(19) United States
(12) Patent Application Publication
(10) Pub. No.: US 2015/0023607 A1
(43) Pub. Date: Jan. 22, 2015

(54) GESTURE RECOGNITION METHOD AND APPARATUS BASED ON ANALYSIS OF MULTIPLE CANDIDATE BOUNDARIES

(71) Applicant: LSI Corporation, San Jose, CA (US)

(72) Inventors: Dmitry N. Babin, Moscow (RU); Ivan L. Mazurenko, Moscow (RU); Alexander A. Petyushko, Moscow (RU); Aleksey A. Letunovskiy, Moscow (RU); Denis V. Zaytsev, Moscow (RU)

(73) Assignee: LSI Corporation, San Jose, CA (US)

(21) Appl. No.: 14/168,391

(22) Filed: Jan. 30, 2014

(30) Foreign Application Priority Data
Jul. 22, 2013 (RU) 2013134325

(51) Int. Cl. G06K 9/00; G06K 9/62

(52) U.S. Cl. CPC G06K 9/00389; G06K 9/6218
USPC 382/225; 382/224

(57) ABSTRACT

An image processing system comprises an image processor configured to identify a plurality of candidate boundaries in an image, to obtain corresponding modified images for respective ones of the candidate boundaries, to apply a mapping function to each of the modified images to generate a corresponding vector, to determine sets of estimates for respective ones of the vectors relative to designated class parameters, and to select a particular one of the candidate boundaries based on the sets of estimates. The designated class parameters may include sets of class parameters for respective ones of a plurality of classes each corresponding to a different gesture to be recognized. The candidate boundaries may comprise candidate palm boundaries associated with a hand in the image. The image processor may be further configured to select a particular one of the plurality of classes to recognize the corresponding gesture based on the sets of estimates.

### CROSS-REFERENCE TO RELATED APPLICATION

This application claims foreign priority to Russia Patent Application No. 2013134325, filed on Jul. 22, 2013, the disclosure of which is incorporated herein by reference.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications such as gesture recognition.

In typical conventional arrangements, raw image data from an image sensor is usually subject to various preprocessing operations. Such preprocessing operations may include, for example, contrast enhancement, histogram equalization, noise reduction, edge highlighting and coordinate space transformation, among many others. The preprocessed image data is then subject to additional processing needed to implement gesture recognition for use in applications such as video gaming systems or other systems implementing a gesture-based human-machine interface.

### SUMMARY

In one embodiment, an image processing system comprises an image processor configured to identify a plurality of candidate boundaries in an image, to obtain corresponding modified images for respective ones of the candidate boundaries, to apply a mapping function to each of the modified images to generate a corresponding vector, to determine sets of estimates for respective ones of the vectors relative to designated class parameters, and to select a particular one of the candidate boundaries based on the sets of estimates.

By way of example only, the designated class parameters may include sets of class parameters for respective ones of a plurality of classes each corresponding to a different gesture to be recognized. The image processor may be further configured to select a particular one of the plurality of classes to recognize the corresponding gesture based on the sets of estimates. Thus, the gesture recognition may be performed jointly with the selection of a particular one of the candidate boundaries.

In some embodiments, the candidate boundaries may comprise candidate palm boundaries associated with a hand in the image.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor configured for palm boundary detection based gesture recognition in an illustrative embodiment.

FIG. 2 shows an image of a hand prior to rotation based on determination of main direction.

FIG. 3 shows the image of FIG. 2 after rotation and with multiple candidate palm boundaries superimposed on the hand.

FIG. 4 illustrates an exemplary training process implemented in the FIG. 1 system.

FIG. 5 is a flow diagram of an exemplary palm boundary detection based gesture recognition process implemented in the FIG. 1 system.

### DETAILED DESCRIPTION

Embodiments of the invention will be illustrated herein in conjunction with exemplary image processing systems that include image processors or other types of processing devices and implement techniques for gesture recognition based on palm boundary detection. It should be understood, however, that embodiments of the invention are more generally applicable to any image processing system or associated device or technique that involves detecting palm boundaries in one or more images.

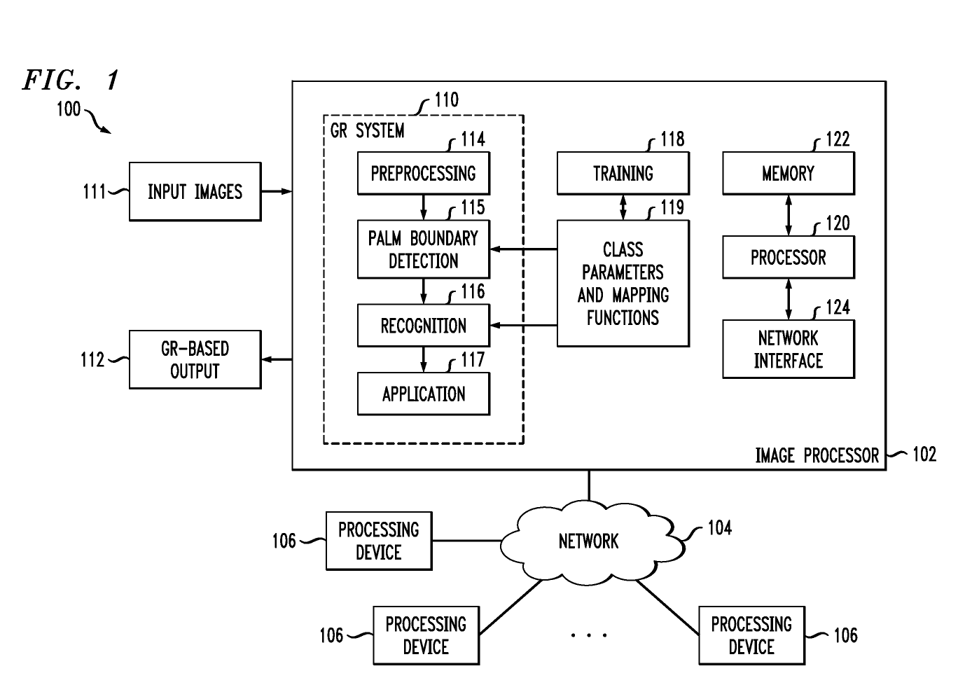

FIG. 1 shows an image processing system 100 in an embodiment of the invention. The image processing system 100 comprises an image processor 102 that is configured for communication over a network 104 with a plurality of processing devices 106. The image processor 102 implements a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

The GR system 110 more particularly comprises a preprocessing module 114, a palm boundary detection module 115, a recognition module 116 and an application module 117. A training module 118 generates class parameters and mapping functions 119 that are utilized by the palm boundary detection and recognition modules 115 and 116 in generating recognition events for processing by the application module 117. Although illustratively shown as residing outside the GR system 110 in the figure, elements 118 and 119 may be at least partially implemented within GR system 110 in other embodiments.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing preprocessing module 114 and a plurality of higher processing layers each configured to implement one or more of palm boundary detection module 115, recognition module 116 and application module 117. Such processing layers may also be referred to herein as respective subsystems of the GR system 110.

It should be noted, however, that embodiments of the invention are not limited to recognition of hand gestures, but can instead be adapted for use in a wide variety of other machine vision applications involving gesture recognition, and may comprise different numbers, types and arrangements of layers in other embodiments.

Also, certain of the processing modules of the image processor 102 may instead be implemented at least in part on other devices in other embodiments. For example, preprocessing module 114 may be implemented at least in part in an image source comprising a depth imager or other type of imager that provides at least a portion of the input images 111. It is also possible that application 117 may be implemented on a different processing device than the palm boundary detection module 115 and the recognition module 116, such as one of the processing devices 106.

Moreover, it is to be appreciated that the image processor 102 may itself comprise multiple distinct processing devices, such that the processing modules 114, 115, 116 and 117 of the GR system 110 are implemented using two or more processing devices. The term “image processor” as used herein is intended to be broadly construed so as to encompass these and other arrangements.

The preprocessing module 114 performs preprocessing operations on received input images 111 from one or more image sources. This received image data in the present embodiment is assumed to comprise raw image data received from a depth sensor, but other types of received image data may be processed in other embodiments. The preprocessing module 114 provides preprocessed image data to the palm boundary detection module 115 and possibly also the recognition module 116.

The raw image data received in the preprocessing module 114 from the depth sensor may include a stream of frames comprising respective depth images, with each such depth image comprising a plurality of depth image pixels. For example, a given depth image D may be provided to the preprocessing module 114 in a form of matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different images sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106. Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to implement gesture recognition based on palm boundary detection.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular number and arrangement of modules shown in image processor 102 in the FIG. 1 embodiment can be varied in other embodiments. For example, in other embodiments two or more of these modules may be combined into a lesser number of modules. An otherwise conventional image processing integrated circuit or other type of image processing circuitry suitably modified to perform processing operations as disclosed herein may be used to implement at least a portion of one or more of the modules 114, 115, 116, 117, 118 and 119 of image processor 102. One possible example of image processing circuitry that may be used in one or more embodiments of the invention is an otherwise conventional graphics processor suitably reconfigured to perform functionality associated with one or more of the modules 114, 115, 116, 117, 118 and 119.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. By way of example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of modules 114 through 119. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

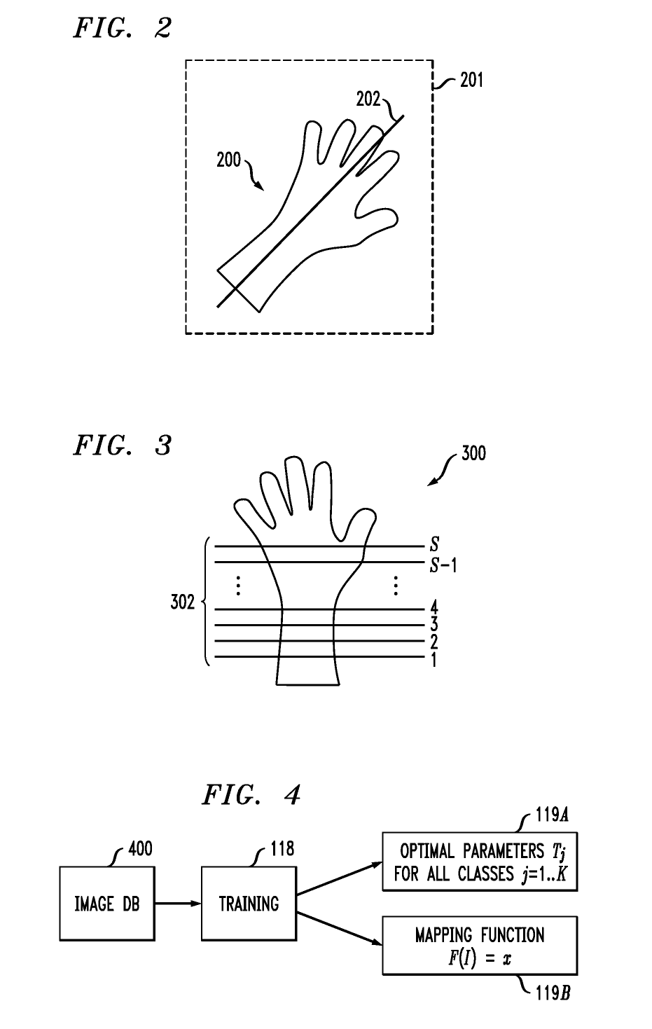

The operation of the image processor 102 will be described in greater detail below in conjunction with FIGS. 2 through 5.

FIG. 2 shows a hand 200 within an image 201. The image 201 may be viewed as one of the input images 111 applied to the image processor 102. In this figure, the hand 200 is angled within the image 201 along an axis corresponding to a main direction 202 of the hand. The preprocessing module 114 receives this input image and performs an orientation normalization operation that illustratively involves rotating the image or portions thereof such that the main direction 202 of the hand 200 corresponds to a known direction. A corresponding hand 300 after rotation is shown in FIG. 3 such that the main direction now substantially coincides with the vertical direction. Thus, the input image has been adjusted such that the main direction of the hand now has a substantially vertical orientation.

The orientation normalization operation used to produce the image of FIG. 3 comprising the rotated hand 300 may be implemented by performing principle component analysis (PCA) to determine the main direction 202 of the hand 200 and then rotating the image 201 by an angle based on the determined main direction.

Other types of normalization can also be applied. For example, scale normalization may be performed by the preprocessing module 114 in conjunction with the above-described orientation normalization. One possible type of scale normalization may involve adjusting the scale of the input image until the ratio of the area occupied by the hand to the total image size matches an average of such ratios for training images in a training database 400 of FIG. 4 used by the training module 118. The scale adjustment may be implemented by applying interpolation to the image based on a scale factor.

In addition or in place of to the rotating and scaling normalizations noted above, shifting normalizations may be applied, as well as various combinations of these and other normalizations.

In some embodiments, instead of applying rotating, scaling, shifting or other normalizations to the input image itself, one or more corresponding normalizing transformations may be applied to a modified image comprising features such as edges that have been extracted from the input image. A given modified image of this type, which may be in the form of an edge image or similar feature map, is intended to be encompassed by the term “image” as generally used herein.

After application of any appropriate normalizations in preprocessing module 114 as described above, the palm boundary detection process begins in palm boundary detection module 115. The palm boundary detection process in the present embodiment initially involves generating multiple candidate images each corresponding to a different candidate palm boundary. Palm boundary detection is completed upon selection of a particular one of these candidate palm boundaries for the given input image. In this embodiment, the palm boundary detection process is assumed to be integrated with the recognition process, and thus modules 115 and 116 may be viewed as collectively performing the associated palm boundary determination and recognition operations.

The term “palm boundary” as used herein is intended to be broadly construed, so as to encompass linear boundaries or other types of boundaries that denote a peripheral area of a palm of a hand in an image. It is to be appreciated, however, that the disclosed techniques can be adapted for use with other types of boundaries in performing gesture recognition in the image processing system 100. Thus, embodiments of the invention are not limited to use with detection of palm boundaries. The module 115 in FIG. 1 can therefore be more generally implemented as a boundary detection module.

Also, embodiments of the invention are not limited to use in recognition of hand gestures, but can be applied to other types of gestures as well. The term “gesture” as used herein is therefore intended to be broadly construed.

Referring again to FIG. 3, multiple candidate palm boundaries 302 are shown superimposed on the rotated hand 300. The candidate palm boundaries in this example are numbered 1, 2, . . . S-1, S as indicated. Each of these palm boundaries is characterized by a substantially horizontal line that separates the hand 300 into a first portion above the boundary and a second portion below the boundary. The candidate palm boundaries are therefore generally oriented in a direction perpendicular to the substantially vertical main direction of the rotated hand 300 of FIG. 3. The palm boundary detection process implemented by palm boundary detection module 114 is generally configured to determine which of such multiple candidate palm boundaries is most appropriate for the corresponding input image that contains hand 300.

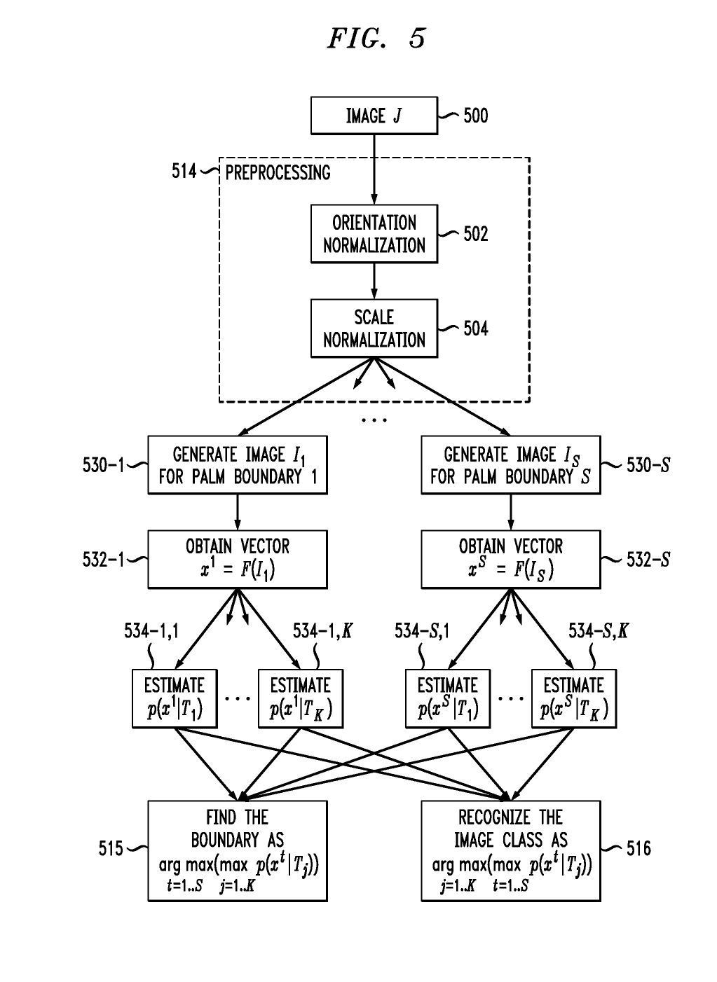

Accordingly, the present embodiment determines the appropriate palm boundary for a given input image by evaluating the multiple candidate palm boundaries. As will be described in more detail below in conjunction with FIG. 5, this process is illustratively performed jointly with classification of the hand gesture, such that the selected palm boundary is the one that in combination with a corresponding classification result provides the highest overall probability relative to the class parameters and mapping functions 119 determined by training module 118 using images from the training database 400 shown in FIG. 4. The joint selection of a particular palm boundary and a corresponding classification result in the present embodiment is therefore based on training where each training sample includes information about the correct palm boundary within a given training image.

The multiple candidate palm boundaries 302 may be determined in a variety of different ways, including, for example, use of fixed, increasing, decreasing or random step sizes between adjacent candidate palm boundaries, as well as combinations of these and possibly other types of inter-boundary step sizes. Although substantially horizontal palm boundaries are used in FIG. 3, other embodiments can use different palm boundaries, such as angled boundaries or combinations of various boundaries of different types.

For each of the candidate palm boundaries, a corresponding image is generated from a given normalized input image I for further processing. In this embodiment, the S different candidate palm boundaries are utilized to generate respective different images I₁, . . . , I_{S}, where the image Iₜ, 1≦t≦S, corresponds to the t-th candidate palm boundary, and is the same as the normalized input image I for pixels above the t-th palm boundary, and has all zeros, ones, average background values or other predetermined values as its pixel values at or below the t-th palm boundary.

Thus, each of the images I₁, . . . , I_{S} has the same pixel values as the normalized input image I for all pixels above its corresponding palm boundary, but has predetermined pixel values for all of its pixels at or below that pixel boundary. Each of the images I₁, . . . , I_{S} may therefore be viewed as being “cut” into first and second portions at the corresponding palm boundary. These images are examples of what are more generally referred to herein as “cut images” or still more generally “modified images” where the modifications are based on the corresponding palm boundaries.

Each such modified image may be characterized as comprising first and second portions on opposite sides of its candidate palm boundary with the first portion of the modified image comprising pixels having values that are the same as those of respective corresponding pixels in a first portion of the normalized image, and the second portion of the modified image comprising pixels having values that are different than the values of respective corresponding pixels in a second portion of the normalized image. In the more particular example given above, the first and second portions of the modified image are portions above and below the candidate palm boundary.

Other types of modified images may be generated based on respective candidate palm boundaries in other embodiments.

Additional details regarding the further processing of cut images I₁, . . . , I_{S} will be described below in conjunction with FIG. 5. As indicated previously, this further processing makes use of class parameters and mapping functions 119 generated by training module 118 using images from the training database 400. The training database 400 may be implemented within image processor 102 possibly utilizing a portion of memory 122 or another suitable storage device or alternatively may be implemented externally to image processor 102 on one or more of the processing devices 106.

It will be assumed that the palm boundary detection and recognition processes implemented in some embodiments of the FIG. 1 system are based on Gaussian Mixture Models (GMMs) although a wide variety of other classification techniques can be used in other embodiments.

A GMM is a statistical multidimensional distribution based on a number of weighted multivariate normal distributions. These weighted multivariate normal distributions may collectively be of the form

$$p ( x ) = {\sum }_{i = 1}^{M} {w}_{i} {p}_{i} ( x ) ,$$

where:

x is an N-dimensional vector x=(x₁, . . . x_{N}) in the space R^{N};

p(x) is the probability of vector x;

M is the number of components or “clusters” in the GMM;

wᵢ is the weight of the i-th cluster where

$${w}_{i} \geq 0 , {\sum }_{i = 1}^{M} {w}_{i} = 1 ;$$

pᵢ(x) is the multivariate normal distribution of the i-th cluster, i.e. pᵢ(x)˜N(μᵢ, Ωᵢ), where μᵢ is an N×1 mean vector and Ωᵢ is an N×N nonnegative-definite covariance matrix such that:

$${p}_{i} ( x ) = \frac{1}{{( 2 π )}^{N / 2} {\vert {Ω}_{i} \vert}^{1 / 2}} {e}^{- \frac{1}{2} {( x - {μ}_{i} )}^{T} {Ω}_{i}^{- 1} ( x - {μ}_{i} )}$$

where T in this equation denotes the transpose operator.

Assume that there are L observations X=(x¹, . . . , x^{L}), where each x^{j}, 1≦j≦L, is an N-dimensional vector in R^{N}, i.e. x^{j}=(x^{j}₁, . . . , x^{j}_{N}). Construction of the GMM in this case may be characterized as an optimization problem that maximizes the overall probabilities of the observations, i.e.

$${arg max}_{{w}_{i} , {μ}_{i} , {Ω}_{i} , i = 1 \cdot M} {\sum }_{j = 1}^{L} p ( {x}^{j} ) .$$

This optimization problem may be solved using the well-known Expectation-Maximization algorithm (EM-alg). EM-alg is an iterative algorithm and may be used to find and adjust the above-noted distribution parameters wᵢ,μᵢ,Ωᵢ for i=1, . . . M. The EM-alg generally involves the following steps:

1. Fill parameters with random values.

2. Expectation step: using observations and parameters from the previous step estimate log-likelihood.

3. Maximization step: find parameters that maximize log-likelihood and update them.

In the context of the FIG. 1 system it may be further assumed that there are multiple observations for each of a plurality of classes corresponding to respective static hand gestures to be recognized by the GR system 110. More particularly, assume there are K classes of observed data, with L_{c} observations for each class c, where 1≦c≦K. In such an arrangement, for each class c the above-described EM-alg may be used to find corresponding optimal parameters T_{c}={wᵢ^{c},μᵢ^{c},Ωᵢ^{c}}ᵢ₌₁^{M} and for any vector x to be classified the recognition result or target class is given by

$${c}_{x} = {arg max}_{c} p ( x \vert {T}_{c} ) .$$

As indicated above, the K classes may correspond to respective ones of a plurality of different static hand gestures, also referred to herein as hand poses, such as, for example, an open palm as illustrated in FIGS. 2 and 3, a fist, a forefinger or “poke” and so on. Other embodiments can be configured to recognize other types of gestures, including dynamic gestures.

The training module 118 processes one or more training images from training database 400 for each of these represented classes. The training database 400 should include training images having properly recognized palm boundaries and associated hand gestures in normalized form. For example, these training images should have substantially the same width and height in pixels, and similar orientation and scale, as the normalized images to be processed by the modules 115 and 116 of the GR system 110. The determination of the appropriate palm boundary in each training image may be determined by an expert and annotated accordingly on the image.

As illustrated in FIG. 4, the training module 118 processes images from the training database 400 in order to generate class parameters 119A including optimal parameters Tⱼ for all of the classes j=1, . . . , K. The training module 118 also generates one or more mapping functions 119B including a mapping function F that when applied to a given normalized input image I from the training database 400 yields a vector x within R^{N}. Typically, the value of N is much less than the number of pixels in the image, and so the processing performed by the training module 118 could be based on features extracted from the image, such as palm width, height, perimeter, area, central moments, etc.

The mapping function F(I)=x=(x₁, . . . , x_{N}) generated by the training module 118 is applied to all L_{c} images from the class c, and then the GMM for the class c is constructed by applying the above-described EM-alg to find the optimal parameters T_{c}={wᵢ^{c},μᵢ^{c},Ωᵢ^{c}}ᵢ₌₁^{M} for the class c. This process is repeated for each of the classes, resulting in K sets of optimal parameters T₁, . . . , T_{K}. As noted above, the class parameters 119A comprising the optimal parameters for each class and the corresponding mapping function 119B are made accessible to the palm boundary detection module 115 and recognition module 116 for use in determining palm boundaries and recognizing gestures in the input images after those images are preprocessed in preprocessing module 114.

Referring now to FIG. 5, an exemplary process is shown for gesture recognition based on palm boundary detection in the image processing system 100 of FIG. 1. The FIG. 5 process is assumed to be implemented by the image processor 102 using its preprocessing module 114, palm boundary detection module 115 and recognition module 116, as well as class parameters and mapping functions 119 provided by training module 118, although one or more of the described operations can be performed by other system components in other embodiments.

It is further assumed in this embodiment that the input images 111 received in the image processor 102 from one or more image sources comprise an input depth image 500 more particularly denoted as image J.

Steps 514, 515 and 516 of the FIG. 5 process generally include preprocessing, palm boundary detection and class recognition operations performed by the respective modules 114, 115 and 116 of the image processor 102. Other related operations are performed in multiple instances of steps 530, 532 and 534.

In the preprocessing step 514, an orientation normalization operation 502 and a scale normalization operation 504 are applied to the input image J to generate a normalized input image I. As previously described in conjunction with FIGS. 2 and 3, the orientation normalization may involve determining main direction 202 of hand 200 within the input image J, possibly using PCA or a similar technique, and then rotating the input image by an amount based on the determined main direction of the hand.

Multiple candidate palm boundaries are then determined in the manner previously described. It is assumed that there are S substantially horizontal candidate palm boundaries of a type similar to that illustrated in FIG. 3.

In steps 530-1 through 530-S, respective cut images I₁, . . . , I_{S} are generated for respective ones of the candidate palm boundaries 1, . . . , S. As noted above, the image Iₜ, 1≦t≦S, corresponds to the t-th candidate palm boundary, and is the same as the normalized input image I for pixels above the t-th palm boundary, and has all zeros, ones, average background values or other predetermined values as its pixel values at or below the t-th palm boundary, such that each of the images I₁, . . . , I_{S} has the same pixel values as the normalized input image I for all pixels above its corresponding palm boundary, but has predetermined pixel values for all of its pixels at or below that pixel boundary. Again, each of the images I₁, . . . , I_{S} may therefore be viewed as being “cut” at the corresponding palm boundary.

In steps 532-1 through 532-S, vectors x¹ through x^{S} are obtained by applying the mapping function F to the respective images I₁, . . . , I_{S}, i.e. vectors x¹=F(I₁), . . . , x^{S}=F(I_{S}). The resulting vectors are also referred to herein as feature vectors.

Steps 534-t,j generally involve determining sets of probabilistic estimates for respective ones of the vectors x¹ through x^{S} relative to sets of optimal parameters where 1≦t≦S and 1≦j≦K. As mentioned above, each of the sets of optimal parameters Tⱼ is associated with a corresponding one of a plurality of static hand gestures to be recognized by the GR system 110. Each set of probabilistic estimates is determined in this embodiment as a set of estimates p(x^{t}|Tⱼ) for a given value of index t relative to sets of optimal parameters Tⱼ where index j takes on integer values between 1 and K. Thus, steps 534-1,1 through 534-1,K determine a first set of probabilistic estimates p(x^{t}|T₁) through p(x^{t}|T_{K}). Similarly, steps 534-S,1 through 534-S,K determine an S-th set of probabilistic estimates p(x^{S}|T₁) through p(x^{S}|T_{K}). Other instances of steps 534 not explicitly shown determine the remaining sets of probabilistic estimates for respective ones of the remaining vectors x² through x^{S-1}.

Step 515 utilizes the resulting sets of probabilistic estimates to select a particular one of the candidate palm boundaries. More particularly, the palm boundary is selected in step 515 in accordance with the following equation:

$$b = {arg max}_{t = 1 … S} ( {max }_{j = 1 … K} p ( {x}^{t} \vert {T}_{j} ) ) \qquad ( 1 )$$

where b denotes the particular palm boundary selected based on the sets of probabilistic estimates, and may take on any integer value between 1 and S.

Step 516 utilizes the same sets of probabilistic estimates to select a particular one of the K image classes. This recognition step more particularly recognizes a given one of the K image classes corresponding to a particular static hand gesture within the input image J, in accordance with the following equation:

$$c = {arg max}_{j = 1 … K} ( {max }_{t = 1 … S} p ( {x}^{t} \vert {T}_{j} ) ) \qquad ( 2 )$$

where c denotes the particular class selected based on the sets of probabilistic estimates, and may take on any integer value between 1 and K.

In other embodiments, other types of estimates may be used. For example, negative log-likelihood (NLL) estimates −log p(xⁱ|Tⱼ) may be used in order to simplify arithmetic computations in some embodiments, in which case all instances of “max” should be replaced with corresponding instances of “min” in equations (1) and (2) of respective steps 515 and 516. The term “estimates” as used herein is intended to be broadly construed so as to encompass NLL estimates of the type noted above as well as other types of estimates that may or may not be based on probabilities.

Also, although GMMs and EM-alg are utilized in the training process in this embodiment, any of a wide variety of other classification techniques may be used in training module 118 to determine appropriate class parameters and mapping functions 119 for use in palm boundary detection and associated gesture recognition operations. For example, well-known techniques based on decision trees, neural networks, or nearest neighbor classification may be adapted for use in embodiments of the invention. These and other techniques can be applied in a straightforward manner to allow estimation of the likelihood function p(x|Tⱼ) for a given feature vector x and a set of optimal parameters Tⱼ for class j. Again, other types of estimates not necessarily of a probabilistic nature may be utilized.

In the FIG. 5 embodiment, the exemplary processing shown not only determines the palm boundary within a given input image but also performs a recognition function by classifying the corresponding gesture. Thus, at least a portion of the processing operations may be viewed as being performed by an integrated palm boundary detection and gesture recognition module. Other embodiments may perform only the palm boundary detection, possibly as part of a preprocessing operation, with recognition being performed as a separate operation based on the detected palm boundary.

The FIG. 5 process can be pipelined in a straightforward manner. For example, at least a portion of the steps can be performed using parallel computations, thereby reducing the overall latency of the process for a given input image, and facilitating implementation of the described techniques in real-time image processing applications.

As a more particular example, the estimates p(xⁱ|Tⱼ) may be calculated independently on parallel processing hardware with intermediate results or final values subsequently combined using the arg max(max( . . . )) function in steps 515 and 516.

At least portions of the GR-based output 112 may be further processed in the image processor 102, or supplied to another processing device 106 or image destination, as mentioned previously.

It is to be appreciated that the particular process steps used in the embodiment of FIG. 5 are exemplary only, and other embodiments can utilize different types and arrangements of image processing operations. For example, the particular manner in which the feature vectors and corresponding sets of estimates are generated can be varied in other embodiments. Also, the computations in steps 515 and 516 are equivalent and therefore can be combined into a single computation in other embodiments. In addition, steps indicated as being performed serially in the figure can be performed at least in part in parallel with one or more other steps in other embodiments. The particular steps and their interconnection as illustrated in FIG. 5 should therefore be viewed as one possible arrangement of process steps in one embodiment, and other embodiments may include additional or alternative process steps arranged in different processing orders.

Embodiments of the invention provide particularly efficient techniques for boundary detection based gesture recognition. For example, one or more of these embodiments can perform joint boundary detection and gesture recognition that allows a system to obtain both boundary and recognition results at substantially the same time. In such an embodiment, the boundary determination is integrated with the recognition process, in a manner that facilitates highly efficient parallel implementation using image processing circuitry on one or more processing devices. The disclosed embodiments can be configured to utilize GMMs or a wide variety of other classification techniques.

It should again be emphasized that the embodiments of the invention as described herein are intended to be illustrative only. For example, other embodiments of the invention can be implemented utilizing a wide variety of different types and arrangements of image processing circuitry, modules and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
identifying a plurality of candidate boundaries in an image;
obtaining corresponding modified images for respective ones of the candidate boundaries;
applying a mapping function to each of the modified images to generate a corresponding vector;
determining sets of estimates for respective ones of the vectors relative to designated class parameters; and
selecting a particular one of the candidate boundaries based on the sets of estimates;
wherein said identifying, obtaining, applying, determining and selecting are implemented in at least one processing device comprising a processor coupled to a memory.

2. The method of claim 1 wherein identifying a plurality of candidate boundaries comprises identifying a plurality of candidate palm boundaries associated with a hand in the image.

3. The method of claim 1 further comprising:
receiving an input image; and
performing one or more normalization operations on the input image to obtain a normalized image in which the candidate boundaries are identified.

4. The method of claim 3 wherein said one or more normalization operations comprise at least one of an orientation normalization and a scale normalization.

5. The method of claim 4 wherein the orientation normalization comprises:
determining a main direction of a hand within the input image; and
rotating the input image by an amount based on the determined main direction of the hand.

6. The method of claim 1 further comprising selecting a particular one of a plurality of classes to recognize a corresponding gesture based on the sets of estimates.

7. The method of claim 1 wherein identifying a plurality of candidate boundaries in the image further comprises determining at least a subset of said boundaries based on one or more of fixed, increasing, decreasing or random step sizes between adjacent candidate boundaries.

8. The method of claim 1 wherein at least a subset of the candidate boundaries comprise candidate palm boundaries oriented in a direction perpendicular to a main direction of a hand in the image.

9. The method of claim 3 wherein each of the modified images comprises first and second portions on opposite sides of its candidate boundary with the first portion of the modified image comprising pixels having values that are the same as those of respective corresponding pixels in a first portion of the normalized image and the second portion of the modified image comprising pixels having values that are different than the values of respective corresponding pixels in a second portion of the normalized image.

10. The method of claim 9 wherein each of the pixels in the second portion of each modified image has the same predetermined value.

11. The method of claim 1 wherein the designated class parameters include sets of class parameters for respective ones of a plurality of classes each corresponding to a different gesture.

12. The method of claim 11 wherein a given one of the sets of class parameters for a particular class c comprises a set of class parameters T_{c}={wᵢ^{c},μᵢ^{c},Ωᵢ^{c}}ᵢ₌₁^{M} based on a Gaussian Mixture Model having M clusters, where wᵢ denotes a weight of an i-th one of the M clusters, and where μᵢ and Ωᵢ denote a mean vector and a covariance matrix, respectively, of a multivariate normal distribution of the i-th cluster.

13. The method of claim 11 wherein a given one of the sets of class parameters for a particular class is generated by applying the mapping function to each of a plurality of training images of the gesture associated with that class to generate a corresponding plurality of vectors and utilizing those vectors to construct a classification model having the given set of class parameters.

14. The method of claim 1 wherein determining sets of estimates for respective ones of the vectors comprises generating a given set of probabilistic estimates p(x^{t}|Tⱼ) for a particular one of the vectors x^{t} relative to sets of class parameters Tⱼ where index t takes on integer values between 1 and S where S denotes the number of candidate boundaries and where index j takes on integer values between 1 and K where K denotes a total number of classes each corresponding to a different gesture.

15. The method of claim 1 wherein determining sets of estimates for respective ones of the vectors comprises generating a given set of negative log-likelihood estimates −log p(x^{t}|Tⱼ) for a particular one of the vectors x^{t} relative to sets of class parameters Tⱼ where index t takes on integer values between 1 and S where S denotes the number of candidate boundaries and where index j takes on integer values between 1 and K where K denotes a total number of classes each corresponding to a different gesture.

16. A computer-readable storage medium having computer program code embodied therein, wherein the computer program code when executed in the processing device causes the processing device to perform the method of claim 1.

17. An apparatus comprising:
at least one processing device comprising a processor coupled to a memory;
wherein said at least one processing device is configured to identify a plurality of candidate boundaries in an image, to obtain corresponding modified images for respective ones of the candidate boundaries, to apply a mapping function to each of the modified images to generate a corresponding vector, to determine sets of estimates for respective ones of the vectors relative to designated class parameters, and to select a particular one of the candidate boundaries based on the sets of estimates.

18. The apparatus of claim 17 wherein the processing device comprises an image processor, the image processor comprising:
a preprocessing module;
a boundary detection module; and
a recognition module configured to select a particular one of a plurality of classes to recognize a corresponding gesture based on the sets of estimates;
wherein said modules are implemented using image processing circuitry comprising at least one graphics processor of the image processor.

19. An integrated circuit comprising the apparatus of claim 17.

20. An image processing system comprising the apparatus of claim 17.
